(19) United States
(12) Patent Application Publication
(10) Pub. No.: US 2024/0351705 A1
(43) Pub. Date: Oct. 24, 2024

(54) Device to Capture Images of the Fuselage of an Airplane and Method to Use Same

(71) Applicants: Charles Ferry, Jacksonville, FL (US); Edward Buschelman, Jacksonville, FL (US); Jeff Necciai, Jacksonville, FL (US); Adrian G. Goldfarb, Jacksonville, FL (US)

(72) Inventors: Charles Ferry, Jacksonville, FL (US); Edward Buschelman, Jacksonville, FL (US); Jeff Necciai, Jacksonville, FL (US); Adrian G. Goldfarb, Jacksonville, FL (US)

(21) Appl. No.: 18/136,405

(22) Filed: Apr. 19, 2023

(51) Int. Cl. B64D 47/08; B64F 5/60; B64U 10/00; H04N 23/56; H04N 23/90

(52) U.S. Cl. CPC B64D 47/08; B64F 5/60; B64U 10/00; H04N 23/56; H04N 23/90; B64U 2101/26; B64U 2101/30

(57) ABSTRACT

The exterior structure or fuselage of an aircraft must be frequently inspected to ensure its structural integrity. A plurality of cameras are mounted on defined structures and capture high resolution images of a stationary aircraft or as the aircraft moves past a designated area. A means of illumination is provided to ensure that the images that are captured are useful. Software is provided to store the captured images and artificial intelligence is used to assist in the analysis or issues that may be related to the exterior surface of the airplane. Cameras may also be mounted to self-directed vehicle, which can be remotely controlled, to capture images.

### CLAIM OF PRIORITY

The applicant claims priority based on the previously filed provisional application with a protective filing date of Apr. 19, 2022 with a corresponding Ser. No. 63/332,348.

### FIELD OF THE INVENTION

Aircraft have been commonplace for many years. Aircraft are used to transport individuals or “souls” or to provide a quick, efficient means to transport material (cargo). Aircraft travel at great speeds and make travel from one location safe as well as comfortable.

All use of aircraft are strictly regulated by specific agencies such as the Federal Aviation Administration in the United States. In the USA, any operation of an aircraft comes under specific rules which are documented in the Federal Air Regulations or FARs.

Depending on the type of operation being conducted, the operation being undertaken has specific rules regarding the flight and its associated operations. These are often referred to as “Part” with a numeric designation such as “Part 91”, “Part 121” or “Part 135”. The operation of an aircraft is covered by these regulations and there are specific sections covering the aircraft, the operating pilot (the Pilot in Command or “PIC”) and other associated rules governing specific operating parameters such as time of day, weather, type of airport to among other factors.

For commercial operators such as United Airlines or Delta, compliance with the regulations is a major part of their cost of operations including the physical cost of compliance with inspections and overhauls and extrinsic costs such as the time that an aircraft spends not earning passenger revenue miles while sitting on the ground and/or in the maintenance hangar. The regulations cover very specific rules regarding mandatory inspections after so many hours of operation, time since the last inspection and extensive inspection and maintenance where the aircraft is literally taken apart, inspected and re-fitted with new parts before it can be declared airworthy.

There are many elements to the inspection of an aircraft and almost all aspects are performed manually with specific experts in airframe and powerplant (“A&P”) conducting the inspections and overseeing removal and refit as necessary. An inspection can be as basic as a Pilot “walkaround” of the aircraft about to be flown where a basic visual inspection is conducted looking for potential defects or other abnormalities or as comprehensive as a complete inspection in a maintenance facility using specialized tools and instruments to look for defects that could be problematic in flight or possibly serious enough to cause catastrophic failure of the airframe's structural integrity.

It is critical that the structural integrity of the aircraft is always maintained. Structural integrity of the aircraft would include ensuring that fuselage and wings are structurally sound without stress defects such as metal fatigue where the constant stress on the airframe from pressurization and de-pressurization, multiple landing cycles and weather events such as extreme turbulence or lightning strikes have not compromised the structure.

In addition, flight control surfaces such as ailerons (for roll control), elevators (pitch-essential for airspeed), rudder(s) (yawing for directional control) flaps and slats (for greater stability at lower airspeeds to avoid stalls) are all correctly attached and operate freely as commanded by the pilot.

Further, the main thrust generators such as turbines and propellers are properly and securely fastened and have no defects such as cracks or loose components such as unfastened nacelles. Additionally, the landing gear which can be fixed or retractable must work properly so the aircraft can take off and land safely, taxi and support the weight of an aircraft carrying a maximum load of cargo and/or passengers. There are many components and moving parts to the aircraft and each of these parts are vital in ensuring the safe operation of the aircraft.

Within the interior of the aircraft, there are multiple systems that must also operate properly. Most of these systems operate using electronic means and include such features as navigation, communication, powered flight control surfaces and additional tools including trim and autopilot, advanced avionics for flight management, and operation of all accessory systems.

This application concerns itself with the ability for the inspection and analysis of aircraft focused on (but not limited to) large (“heavy”), mid-size and regional aircraft to visually inspect and visually recreate images of the exterior of the aircraft as it is travelling within the confines of the airport, as it moves from the terminal to the runway or after it has landed and moves to the terminal or when the plane is in a hangar. The objective of the system will be to produce a comprehensive report about the aircraft condition identifying symptoms that could identify potential defects. The data would include visual and electronic data from a range of sources including standard images, line-scan, and aircraft technical data supplied by the aircraft's own electronic systems. The ultimate goal is to cover all aircraft components including airframe, powerplant and systems.

A plane frequently travels along concrete and asphalt Surfaces as it travels from the gate to a position for takeoff. The surface on which a plane moves is often referred to as the tarmac, which describes the type of surface on the ground. As the plane moves from location to location within the area of the airport, the plane is moving at a relatively slow speed in a very controlled environment. The movement of a plane at a public airport with a control tower is directed by communication between a controller within the tower and the Pilot (typically the captain) who must follow the directions for ground movement given by the controller if the airport is designated a controlled “field”.

Failure to observe these directions can result in situations where an aircraft unintentionally crosses an active runway. Each Airport has a specific layout consisting of runways, taxiways, taxi lanes, ramps, aircraft stands or jetways as well as other areas for specific purposes such as maintenance hangars and waiting positions.

The design of an airport is under the guidelines issued by the FAA in and Advisory Circular (AC) 150/5300-13 (x) where (x) is a letter designating the latest version of the AC.

There can be multiple runways in an airport to account for variations such as accommodating different types of aircraft (large, small, fixed-wing or rotorcraft) as well as the direction of the wind on any given day.

### PRIOR ART

There are many references to devices that scan moving objects such as trucks, vans, and cars. In the area of airplane inspection there appear to be few if any automated scanning systems. There are various specialized tools for use during inspections but typically are operated by an individual in a manual operation and relying on the skill of that operator. There also are a few drone companies that claim the ability to perform scans but these are limited in scope and do not form part of a comprehensive review of the aircraft and have limited report generation or ability to generate defect identification using tools such as Artificial Intelligence models.

This patent applicant does already perform such complex analysis on trains and has patents covering certain unique techniques.

Representative examples of the prior art include Drayton U.S. Pat. No. 11,186,386. This is a method, apparatus and system for inspecting the fuselage of an aircraft. The inspection equipment is attached to a rail, and the rail extends throughout the interior portion of the fuselage. This does not, however, employ autonomous vehicles, self-directed vehicles, robots, or drones to get a close-up view of the fuselage of the airplane as anticipated by the current application.

Another prior art reference can be found at Shi U.S. U.S. Pat. No. 9,747,564. This is a system and method for analyzing aircraft operation and maintenance history to include maintenance reports, aircraft type systems, failure history, health management reports, and aircraft exterior structural conditions to produce a real-time recommendation regarding aircraft maintenance and dispatch. This however, again, does not use drones, robots, self-directed vehicles, or autonomous vehicles to assist in the inspection process.

Another representative example in the prior art can be found at Engle U.S. Patent Publication 2017/0297745. This provides a simplified inspection of an aircraft by the pilot. It does include at least one moveable inspection unit in a position detection arrangement and at least one data transfer interface.

The current application uses many different types of moveable objects, including autonomous vehicles, self-directed vehicles, drones, and robots to capture high-resolution images of all exterior surfaces of an airplane, which is not anticipated by the Engle reference.

A final example can be found at Wang U.S. Pat. No. 10,690,24. This is an unmanned aerial vehicle control system and method and an unmanned aerial vehicle landing control method. This is an unmanned aerial vehicle, which includes a fuselage, a power device connected to the fuselage, and a control device disposed of the fuselage and electronically connected with the power device. This is non-specific and is more of a description of a drone and is not targeting an inspection method to assess the fuselage of an airplane.

These are just representative of the prior art. However, none of the prior art references entail a comprehensive view of the aircraft as taught by the current application.

### BRIEF SUMMARY OF THE INVENTION

In this application, the aircraft could be inspected using one of three different methodologies: in a maintenance facility, at a special inspection portal located in a special operations area of the airport or as the aircraft moves along a taxiway.

In the first instance, an aircraft is towed into a maintenance facility for scheduled maintenance. A specialized portal consisting of gantries with multiple systems including area and line scan cameras, x-ray scanners, and acoustic scanners (ultrasound) would “encase” the fuselage and conduct an automated scanning of the fuselage for physical damage, “hidden” damage such as stress cracks or other damage not visible to a cursory inspection, pinholes in the fuselage due to lightning strikes, powerplant analysis for potential failures of fan blades or hydraulic leaks, and electronic systems analysis using diagnostic tools that log issues including failing components.

In the second instance, an aircraft could be directed to a special inspection portal based on a request by the crew, company operations or airport directive. The aircraft would taxi or be towed through an inspection portal that is located in a special airport operations area where a real-time inspection could be performed using certain technologies as described in the first instance above. The objective would be to discover anything that could be deemed an immediate safety issue and shorten the time for a potential fix and return to service by knowing of an issue or issues earlier in the operation cycle. In this case, a set of structures or portal is mounted to the edges of the special operation area and outside the path of the aircraft. On this structure a plurality of cameras is mounted. The cameras can be operated in all-weather conditions and under all temperature extremes. The cameras capture images of the outside of the aircraft as it passes between the structures on which the cameras are mounted. A report with detailed specific analyses with any potential defects cited is compiled and passed to the airline for further maintenance review and action.

The third instance envisions aircraft being regularly scanned during operations (post-landing) by having the aircraft “scanned” and using the methods described above but in a manner that adds minimal interruption to flight operations. The aircraft would transit a special portal that is located in a common area where a real-time inspection could be performed as described in the second instance above. The objective would be to discover anything that could be deemed a safety issue and shorten the time for potential out of service time and keep the aircraft in service by identifying issues during the operation cycle.

In most airports the flow of planes between the structures is anticipated to be constant. It is anticipated that the portal will be activated as the aircraft travels from the runway after landing to the terminal along a taxiway or another designated area where, post scan, the Aircraft may continue its travel to the designated gate. It may also be used with an aircraft that is travelling from the terminal to the runway via a designated taxiway or special operations area prior to takeoff.

As the aircraft passes by the structure or portal, special cameras, lasers or other visual devices will capture data including high resolution images, scans or other meaningful representations (“images”), in all environmental conditions and temperature extremes of the outside structure of the aircraft. Several proprietary techniques will be used to capture the images of the aircraft as whole images or thin “slices” of the aircraft and software will stitch the images back to form the image of the aircraft in whole or in part. This image data of the aircraft can then be used to compile a report of potential maintenance or safety defects that can be transmitted to a remote facility for further investigation, maintenance, or repair purposes.

In addition to the structure with the fixed cameras capturing various elements of the aircraft structure, other visual capture techniques can be deployed including drone and/or autonomous vehicles which will be used to capture specific images and data where the fixed cameras may be challenged such as looking under the aircraft and detailed examinations of critical flight components using oblique views, laser analysis or other visual technologies; the drones or autonomous vehicles can take high image resolutions of the aircraft from a much closer distance and from different angles.

The portal will not interfere with airport operations and will comply in all respects with the FAA Advisory Circular described previously. It will not slow the aircraft down nor interrupt the natural flow of airport traffic post landing or prior to takeoff. The decision to scan will be the operator's decision in the same manner that other operations such as de-icing are determined.

Additionally, the use of artificial intelligence will be employed to highlight those areas of possible concern to alert the operator of the aircraft of any possible maintenance or repair issues. A post-landing or pre-takeoff report would be available in real-time to the operator's flight-crew, operations staff and maintenance personnel for documentation purposes or for immediate action as appropriate. In addition, the system will offer an additional function in that it will be capable of “talking” directly to the aircraft's systems for diagnostic purposes or identification of anomalies such as the reason for random warning lights in the cockpit or erroneous instrument readings.

### BRIEF DESCRIPTION OF THE DRAWINGS

FIG. 1 is a depiction of the system on the tarmac.

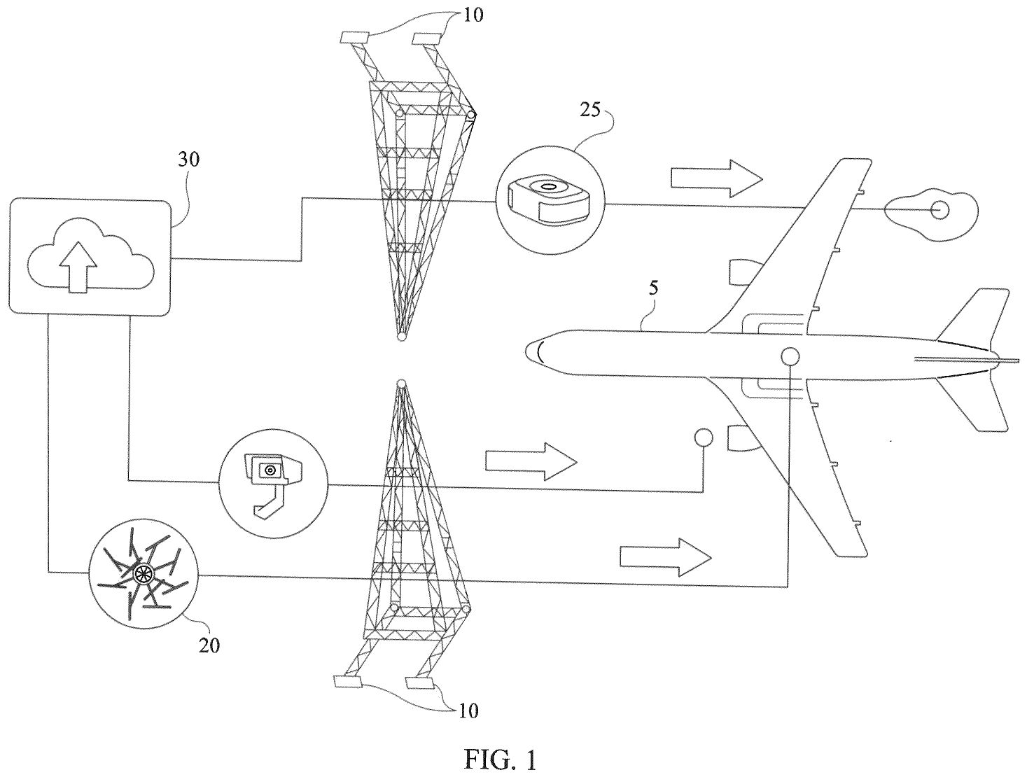

FIG. 2 is a depiction of the system in a hanger.

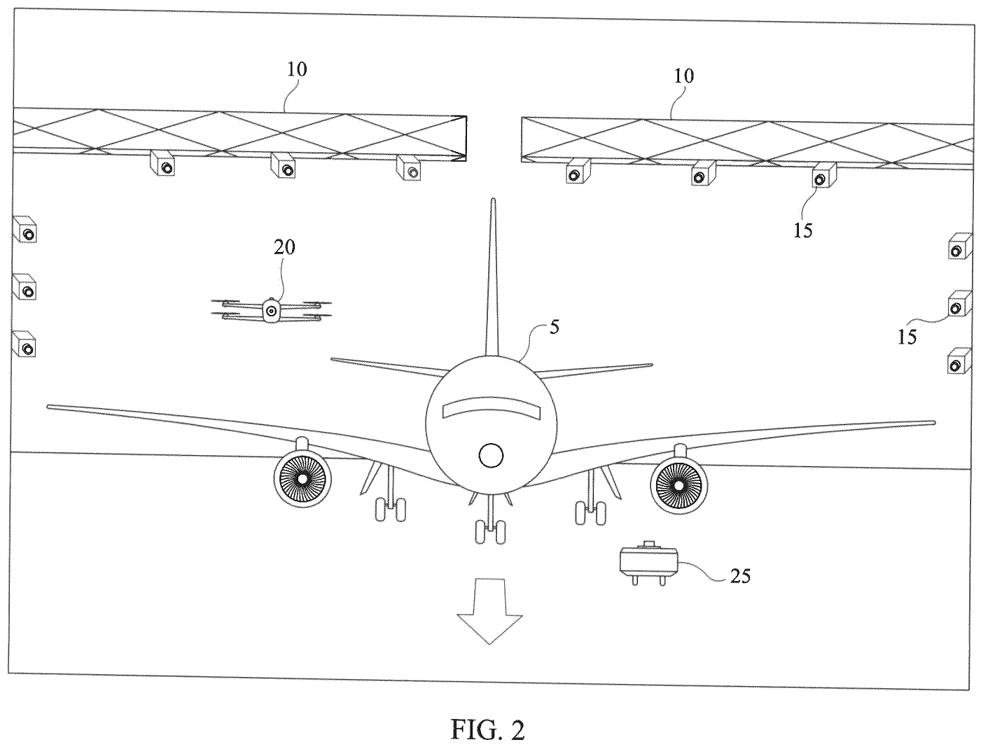

FIG. 3 is a schematic of the components of the device.

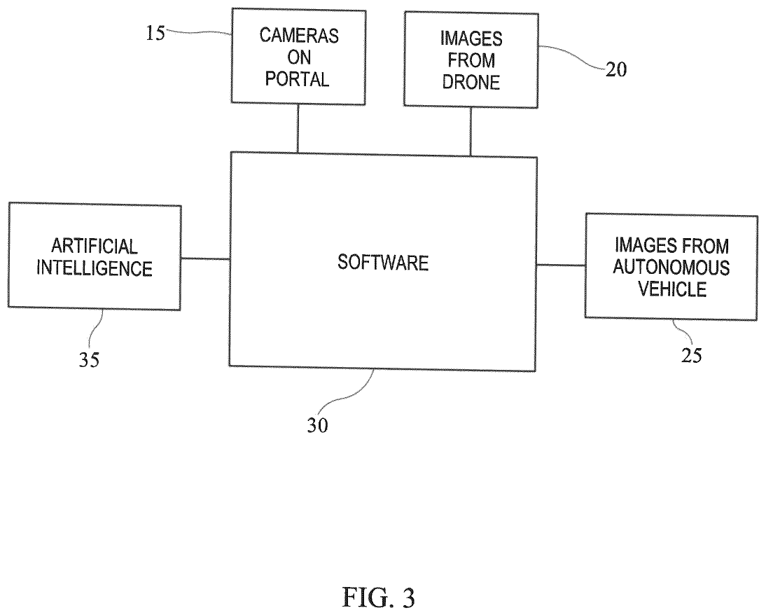

FIG. 4 is a depiction of an aircraft is a closed hangar or maintenance facility.

### NUMBERING REFERENCES

5 Aircraft
10 Inspection portal
12 Hangar
15 Camera
17 Gantry Mounted Camera
20 Drone
25 Autonomous Vehicle
30 Software
35 Artificial Intelligence

### DETAILED DESCRIPTION OF THE EMBODIMENTS

As the aircraft 5 moves along the tarmac of the airport, it will pass between a set of fixed structures 10. On this fixed structure or inspection portal 10 will be a plurality of cameras 15 which can take high resolution images of the aircraft as it passes between the two structures of the inspection portal. The plurality of cameras are mounted to the structure of the maintenance facility, the sides of the portal, or are embedded in autonomous vehicles, drones that can travel around the aircraft and capture high resolution images of the exterior of the aircraft surfaces. Adequate illumination is required regardless of the embodiment that is being anticipated.

It is anticipated that there will be three distinct embodiments for this application. The first embodiment anticipates that the aircraft will be inspected in a maintenance facility. The second embodiment anticipates a specifically designed inspection portal that is located in a designated, special operations area of the airport. The third embodiment anticipates an inspection of the aircraft as it moves along a taxiway either prior to takeoff or after landing. Regardless of specific embodiment the concept remains the same although the aircraft is stationary in two embodiments and is moving in the third embodiment.

It is anticipated that the cameras used in all the embodiments will capture high resolution images in all environmental conditions and all environmental conditions. The cameras may also be equipped to capture infrared images.

### First Embodiment

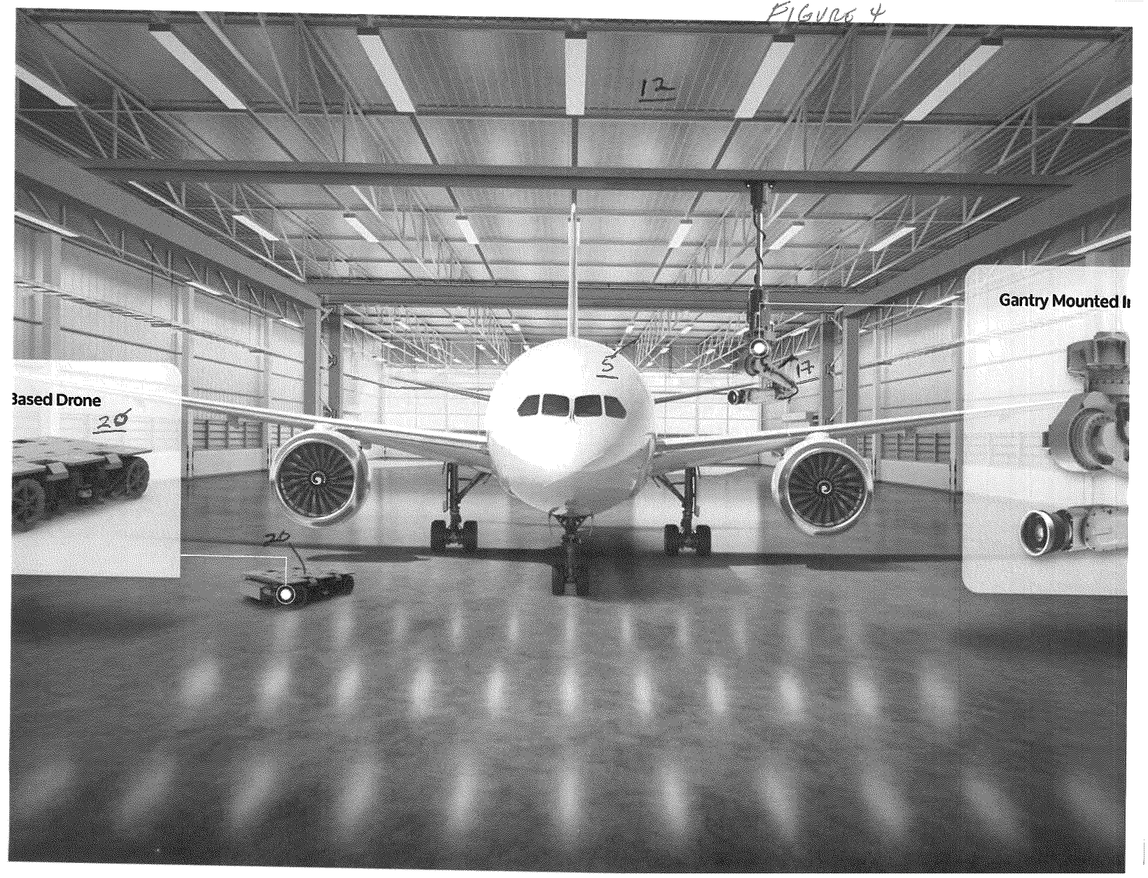

In the first embodiment the aircraft is placed in a hangar 12 or maintenance facility, which is a large permanent structure with defined walls and a defined top surface and openings to allow the aircraft an entrance and an exit; the placement in the maintenance facility can be dictated because of a normal inspection schedule or to fix any issues related to the aircraft. Referring to FIG. 4 the aircraft 5 is placed in the hangar 12 or maintenance facility and the use of drones 20 with cameras and gantry mounted cameras 17 will enable a close-up inspection of the aircraft in the hangar 12, particularly those areas that are difficult to visually inspect without special equipment.

In the hangar or maintenance facility the plane is stationary and all parts of the plane—inside and outside of the plane—can be inspected by experts and technicians. However, the use of autonomous vehicles 25, drones 20 and cameras mounted to the interior structure of the maintenance facility will enable a more thorough inspection of all the outside surfaces of the aircraft that is not possible by human efforts alone. The hangar or maintenance facility 12 is also shielded from the elements.

### Second Embodiment

The second embodiment anticipates that a separate stand alone portal will be constructed in a designated area of the airport. The aircraft would be positioned adjacent to the portal and would be stationary. On the portal cameras, self driving vehicles, drones 20 or autonomous vehicles 25 are equipped with cameras that will capture high resolution images of all the exterior surfaces of the stationary airplane in the portal. The portal may or may not be enclosed and consequently, may or may not be protected from the elements.

### Third Embodiment

In the third embodiment the aircraft 5 is moving and will pass through the portal 10 that has been erected in a designated area of the airport. It is anticipated that the portal will be mounted to the ground adjacent to a taxiway. As an aircraft travels to takeoff the aircraft will pass by the portal. Cameras 15 will be mounted on the portal 10 structure and the cameras 15 will take high resolution images in a fragmented form or thin slices of images as the plane moves past the portal. These fragmented pieces will then be restitched by software 30 as the aircraft moves through the portal 10 and transmitted to a remote location for analysis.

A means of illumination will be provided on the portal 10 for periods of darkness and periods of low visibility in the third embodiment. Because the third embodiment the portal is erected adjacent to the taxiway, lighting issues may be Regardless of the size of the portal in the problematic. third embodiment, the portal will be erected to not interfere with the normal traffic flow of planes as aircraft travel along the tarmac.

Additionally, a self-directed vehicle such as an autonomous vehicle 25, a robot, or a drone 20, will also be employed to capture high resolution images of the fuselage that are closer to the aircraft and from different angles as it passes by the portal. These self-directed vehicles will employ the same software 30 and capture images in fragmented form and then restitch the images to form the image of the fuselage of the aircraft.

The advantage of the self-directed vehicle is the ability to obtain closeup images of the fuselage from short distances and at different angles. Regardless of the type of self-directed device that is used, each of the devices is equipped with a camera or cameras that can capture high resolution images of the fuselage of the aircraft. The self-directed devices will enable extreme closeup views of the aircraft and can maneuver around the aircraft to take images of all the surfaces of the aircraft. These images will be transmitted to a remote location for analysis using software 30 that can gather the images and restitch the images to form an image of the fuselage of the plane.

Software 30 will be provided to store the images that are captured by the plurality of cameras; the storage of the capture images will be hosted on a central platform. Artificial intelligence 35 will be used to provide an alert for possible suspicious areas and to alert the owner or operator of the aircraft of any possible issues. The self-directed vehicles will be operated remotely.

While the embodiments of the invention have been disclosed, certain modifications may be made by those skilled in the art to modify the invention without departing from the spirit of the invention.

1. A device to capture images of the fuselage of an aircraft which is comprised of:
a maintenance facility,
wherein the maintenance facility has a defined structure;
means of illumination;
a first set of a plurality of cameras;
wherein the first set of the plurality of cameras are secured to the maintenance facility;
a second set of plurality of cameras;
wherein the second set of the plurality of cameras is affixed to a self-directed vehicle;
wherein the plurality of cameras capture high resolution images of the exterior surface of an aircraft;
wherein the cameras operate in conditions of low lighting;
wherein the cameras operate in all environmental conditions;
illumination means;
software,
wherein artificial intelligence is incorporated into the software;
wherein the images are stored on a central platform.

2. A device to capture images of the fuselage of an aircraft which is comprised of:
a portal,
wherein the portal is secured to the ground;
wherein the portal has a defined structure;
a first set of a plurality of cameras;
wherein the first set of the plurality of cameras are affixed to the portal structure;
a second set of a plurality of cameras,
wherein the second set of the plurality of cameras are affixed to a self-directed vehicle;
wherein the plurality of cameras capture high resolution images of the exterior surface of an aircraft;
wherein the cameras operate in conditions of low lighting;
wherein the cameras operate in all environmental conditions;
illumination means;
software,
wherein artificial intelligence is incorporated into the software;
wherein the images are stored on a central platform.

3. A device to capture images of the fuselage of an aircraft which is comprised of:
a portal,
wherein the portal is secured to the ground;
wherein the portal has a defined structure;
a first set of a plurality of cameras;
wherein the first set of the plurality of cameras are secured to the portal;
a second set of plurality of cameras;
wherein the second set of the plurality of cameras is affixed to a self-directed vehicle;
means of illumination,
wherein the cameras operate in conditions of low lighting;
wherein the cameras operate in all environmental conditions;
wherein the plurality of cameras capture high resolution images of the exterior of the aircraft as it travels past the portal;
a self-directed vehicle;
wherein secondary cameras are installed in the self-directed directed vehicles;
software;
wherein artificial intelligence is incorporated into the software;
illumination means;
software,
wherein the images are stored on a central platform.

4. The device to capture images of the fuselage of an aircraft as described in claim 1 wherein the self-directed vehicle is an autonomous vehicle.

5. The device to capture images of the fuselage of an aircraft as described in claim 1 wherein the self-directed vehicle is a drone.

6. The device to capture images of the fuselage of an aircraft as described in claim 1 wherein the self-directed vehicle is a robot.

7. The device to capture images of the fuselage of an aircraft as described in claim 1 wherein the camera is a line scan camera.

8. The device to capture images of the fuselage of an aircraft as described in claim 1 wherein the camera is an area scan camera.

9. The device to capture images of the fuselage of an aircraft as described in claim 1 wherein the means of illumination is a plurality of LED lighting.

10. The device to capture images of the fuselage of an aircraft as described in claim 1 wherein the means of illumination is stadium lighting.

11. The device to capture images of the fuselage of an aircraft as described in claim 1 wherein the means of illumination is controlled by a timer.
